(19) United States
(12) Patent Application Publication
(10) Pub. No.: US 2007/0153837 A1
(43) Pub. Date: Jul. 5, 2007

(54) Device, system and method of frequency tracking for clock and data recovery

(76) Inventors: Alon Meir, Jerusalem (IL); Vladimir Kravtsov, Jerusalem (IL)

Correspondence Address: PEARL COHEN ZEDEK LATZER, LLP, 1500 BROADWAY 12TH FLOOR, NEW YORK, NY, 10036, US

(21) Appl. No.: 11/321,049

(22) Filed: Dec. 30, 2005

(51) Int. Cl. H04J 3/06

(52) U.S. Cl. 370/503

(57) ABSTRACT

Embodiments of the invention provide devices, systems and methods of frequency tracking, e.g., for clock and data recovery. For example, a device according to embodiments of the invention includes a frequency tracker to correct a frequency offset of a received signal in response to an overflow signal of a variable-step counter that uses a variable step increment value. The step increment value may be generated in response to a count of one or more advance indications, a count of one or more retard indications, and a current trend of the advance and retard indications. The frequency tracker may be able to track small frequency offsets and/or large frequency offsets, thereby allowing accurate control of a sampling position control. Other features are described and claimed.

### BACKGROUND OF THE INVENTION

High-speed serial transmission protocols, e.g., those used by PCI (peripheral component interconnect) express (PCIe), may carry clocking information embedded with a data signal. For example, a PCIe link between two PCIe devices supports a data-rate of 2.5 gigabits per second (GHz), at which the PCIe devices are adapted to receive the serial data.

A clock and data recovery (CDR) unit may be applied to change the sampling point of a received bitstream according to the received data and/or embedded clocking information, e.g., to lower the bit error rate (BER) and thereby improve the available bandwidth of a communication link. In practice, a theoretical data rate of 2.5 GHz may be received at a rate of 2.5 gigabits per second with a frequency offset of, e.g., ±100 parts per million (ppm). If this frequency offset is ignored, it may cause errors due to missed and/or oversampled bits.

Jitter may be caused, for example, by variation of one or more signal characteristics, e.g., change in the frequency or phase of successive cycles. A CDR unit may include a filter to handle low frequency jitter, as well as a frequency tracker to handle higher frequency changes, e.g., when the rate of the jitter includes significant variation.

A CDR unit may not be able to track a small frequency offset, e.g., less than 125 ppm, and may consequently treat the change as jitter instead. However, lack of adequate frequency tracking may enlarge the internal jitter of the clock recovery circuit, thereby reducing the tolerance of the receiver to jitter in the signal, and increasing BER per signal-jitter. This problem may be acute, for example, in cases where the transmitter clock and the receiver clock are in close alignment, e.g., two PCIe devices using the same crystal but separate phase-locked loops (PLLs).

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic illustration of a communication system including a station utilizing frequency tracking in accordance with some demonstrative embodiments of the present invention;

FIG. 2 is a schematic illustration of a clock and data recovery unit of a receiver in accordance with some demonstrative embodiments of the invention;

FIG. 3 is a schematic graph of counter values as a function of time, useful in demonstrating aspects of frequency tracking in accordance with some demonstrative embodiments of the invention; and

FIG. 4 is a schematic graph showing jitter versus frequency offset when using a frequency tracker in accordance with one demonstrative embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Some embodiments of the invention may be used in conjunction with many apparatuses and systems, for example, a transmitter, a receiver, a transceiver, a transmitter-receiver, a wireless communication station, a wireless communication device, a wireless access point (AP), a modem, a wireless modem, a personal computer, a desktop computer, a mobile computer, a laptop computer, a notebook computer, a personal digital assistant (PDA) device, a tablet computer, a server computer, a network, a wireless network, a local area network (LAN), a wireless LAN (WLAN), devices and/or networks operating in accordance with existing IEEE 802.11, 802.11a, 802.11b, 802.11e, 802.11 g, 802.11h, 802.11i, 802.11n, 802.16 standards and/or future versions of the above standards, a personal area network (PAN), a wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a personal communication systems (PCS) device, a PDA device which incorporates a wireless communication device, a multiple input multiple output (MIMO) transceiver or device, a single input multiple output (SIMO) transceiver or device, a multiple input single output (MISO) transceiver or device, a multi receiver chain (MRC) tansceiver or device, a transceiver or device having “smart antenna” technology or multiple antenna technology, or the like. Some embodiments of the invention may be used in conjunction with one or more types of wireless communication signals and/or systems, for example, radio frequency (RF), infra red (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, multi-carrier modulation (MDM), or the like. Embodiments of the invention may be used in various other apparatuses, devices, systems and/or networks.

Although embodiments of the invention are not limited in this regard, discussions utilizing terms such as, for example, “processing,” “computing,” “calculating,” “determining,” “establishing”, “analyzing”, “checking”, or the like, may refer to operations and/or processes of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, parameters, or the like. For example, “a plurality of stations” may include two or more stations.

Although embodiments of the invention are not limited in this regard, the term “jitter” as used herein may include, for example, an unwanted variation of one or more characteristics of a signal, e.g., in amplitude, phase, timing, or width of signal pulse. In particular, jitter may include a time and/or frequency displacement of a signal edge from its expected position. Jitter may be caused, e.g., by amplitude degradations, by electromagnetic interference (EMI), by crosstalk among multiple signals, by displacement caused by interference, or the like.

Although embodiments of the invention are not limited in this regard, the term “frequency offset” as used herein may include, for example, a difference between a frequency of a signal and a reference frequency, a frequency deviation, a frequency shift, or the like.

Although portions of the discussion herein may relate, for demonstrative purposes, to a wireless communication system, a wireless transmitter and/or a wireless receiver, embodiments of the invention are not limited in this regard, and may be used, for example, in conjunction with non-wireless (e.g., wired) communication systems, transmitters and/or receivers, e.g., PCI (peripheral component interconnect) express (PCIe) communications and/or systems. For example, some demonstrative embodiments of the invention may be used in systems and/or devices adapted for communication of high-speed serial data, e.g., at speeds of over 1 GHz, in which clock and data recovery may be desired.

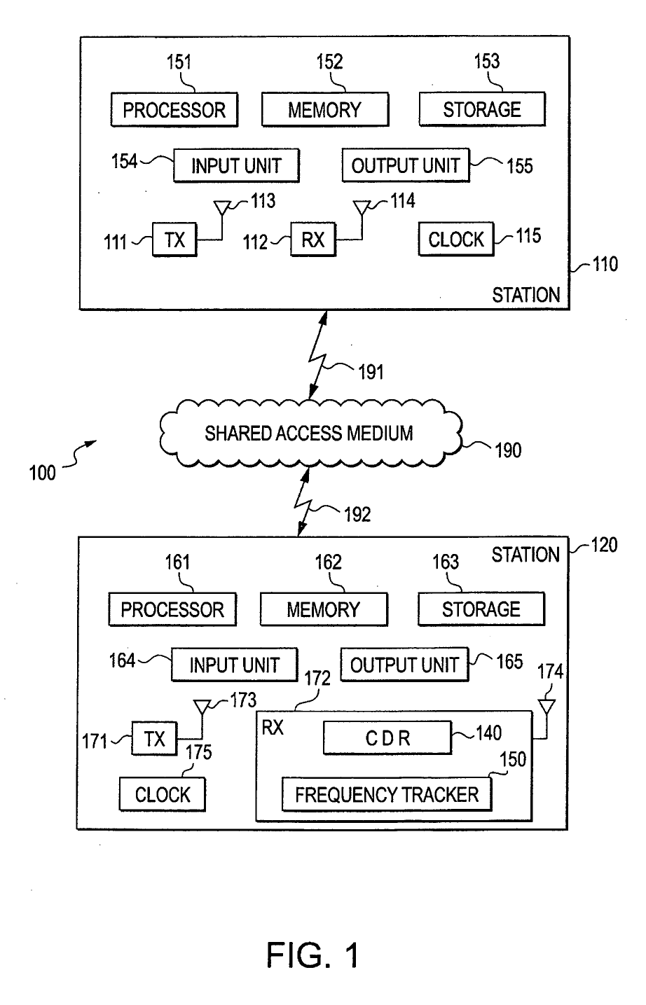

FIG. 1 schematically illustrates a block diagram of a communication system 100 utilizing frequency tracking in accordance with an embodiment of the invention. System 100 may include one or more communication stations or devices, for example, stations 110 and 120. System 100 may optionally include other wireless devices, for example, an access point (AP), a base station, a servicing station, or the like. Stations 110 and 120 may communicate using a shared access medium 190, for example, through wireless communication links 191 and 192, respectively.

In some embodiments, system 100 may be or may include one or more wireless communication networks, for example, an a-synchronic wireless network, an asynchronous wireless network, a synchronic wireless network, a burstable wireless network, a non-burstable wireless network, a hybrid network, a combination of one or more networks, or the like. In other embodiments, for example, system 100 may be implemented as a wired communication system, including, for example, one or more computing platforms, processing platforms, PCIe devices, PCIe transmitters/receivers, serializer/deserializer (SerDes) devices, SerDes transmitters/receivers, or the like.

Although embodiments of the invention are not limited in this respect, station 110 may include, for example, a processor 151, a memory unit 152, a storage unit 153, an input unit 154, an output unit 155, a transmitter 111, a receiver 112, and a clock 115. Station 110 may optionally include other suitable hardware components and/or software components. In some embodiments, the components of station 110 may be enclosed in, for example, a common housing, packaging, or the like. Similarly, station 120 may include, for example, a processor 161, a memory unit 162, a storage unit 163, an input unit 164, an output unit 165, a transmitter 171, a receiver 172, and a clock 175. Station 120 may optionally include other suitable hardware components and/or software components. In some embodiments, the components of station 120 may be enclosed in, for example, a common housing, packaging, or the like.

Although embodiments of the invention are not limited in this respect, processors 151 and 161 may include, for example, a central processing unit (CPU), a digital signal processor (DSP), a microprocessor, a controller, a chip, a microchip, an integrated circuit (IC), or any other suitable multipurpose or specific processor or controller. Memory units 152 and 162 may include, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units.

Although embodiments of the invention are not limited in this respect, storage units 153 and 163 may include, for example, a hard disk drive, a floppy disk drive, a compact disk (CD) drive, a CD-ROM drive, or other suitable removable or non-removable storage units. Input units 154 and 164 may include, for example, a keyboard, a keypad, a mouse, a touch-pad, a microphone, or other suitable pointing device or input device. Output units 155 and 165 may include, for example, a cathode ray tube (CRT) monitor or display unit, a liquid crystal display (LCD) monitor or display unit, a screen, a monitor, a speaker, or other suitable display unit or output device.

Although embodiments of the invention are not limited in this respect, transmitters 111 and 171 may include, for example, a wired or wireless transmitter, e.g., a PCIe transmitter, a SerDes transmitter, or a wireless Radio Frequency (RF) transmitter able to transmit RF signals, e.g., through an antenna 113 or 173, respectively. Receivers 112 and 172 may include, for example, a wired or wireless receiver, e.g., a PCIe receiver, a SerDes receiver, or a wireless RF receiver able to receive RF signals, e.g., through an antenna 114 or 174, respectively.

In embodiments wherein system 100 is implemented as a wireless communication system, antennas 113 and 173 and/or antennas 114 and 174 may include an internal and/or external RF antenna, for example, a dipole antenna, a monopole antenna, an omni-directional antenna, an end fed antenna, a circularly polarized antenna, a micro-strip antenna, a diversity antenna, or any other type of antenna suitable for transmitting and/or receiving wireless communication signals, blocks, frames, transmission streams, packets, messages and/or data.

In some embodiments, transmitters 111 and 171 and/or receivers 112 and 172 may be implemented, for example, using a transceiver, a transmitter-receiver, or one or more units able to perform separate or integrated functions of transmitting and/or receiving wired or wireless communication signals, blocks, frames, transmission streams, packets, messages and/or data, e.g., high-speed serial data. In some embodiments, transmitters 111 and 171 and/or receivers 112 and 172 may be able to operate in accordance with one or more wired or wireless communication standards or protocols, for example, IEEE 802.11 standard, IEEE 802.16 standard, BlueTooth, PCIe, SerDes, or the like.

Clocks 115 and 175 may include, for example, a real-time clock, a system clock, a counter, a timer, a component able to perform timing or counting operations, a component able to track time, a component able to provide time data or time parameters, or the like. In some embodiments, clocks 115 and 175 may be operationally associated with transmitters 111 and 171, respectively, and/or receivers 112 and 172, respectively. In some embodiments, for example, transmitter 111 and receiver 112 may utilize a shared crystal of clock 115, though transmitter 111 may utilize a first phase-locked loop (PLL) and receiver 112 may utilize a second PLL. Similarly, in some embodiments, for example, transmitter 171 and receiver 172 may utilize a shared crystal of clock 175, though transmitter 171 may utilize a PLL and receiver 172 may utilize a second PLL.

In some embodiments, for example, transmitter 111 of station 110 may transmit signals carrying data, e.g., high-speed serial data, to receiver 172 of station 120. In accordance with a transmission protocol utilized by transmitter 111, clocking information or other timing information may be embedded in signals transmitted by transmitter 111. It will be appreciated that such embedded clocking information may allow reconstruction of transmitter clock 115 from the received data, for example, by analyzing the position of one or more edges of the received data. Although embodiments of the invention are not limited in this respect, the transmission protocol utilized by transmitter 111 may specify a minimum number data edges, corresponding to the transmitter clock edges, per transmission period in order to allow proper tracking of the clock.

In some embodiments, a signal transmitted by transmitter 111 may be degraded or distorted while passing through shared access medium 190, e.g., due to temperature differences or due to other physical phenomena. The signal degradation may result in, for example, signal jitter, e.g., a drifting frequency in the signal received by receiver 172. For example, one or more characteristics of the signal received by receiver 172 of station 120 may not be identical to one or more, respective, characteristics of the signal transmitted by transmitter 111 of station 110.

In some embodiments, clock 175 of station 120 may be synchronized or substantially synchronized to clock 115 of station 110. For example, in the case of two devices using the same crystal but separate PLLs, e.g., two PCIe devices, two SerDes devices, or the like. As a result, the signal received by receiver 172 of station 120 may have a relatively small frequency offset relative to the signal transmitted by transmitter 111 of station 110.

Receiver 172 may include, or may be operatively associated with, a clock and data recovery (CDR) unit 140. The CDR unit 140 may, for example, detect an optimal or nearly optimal sampling point of one or more data bits in the signal received by receiver 172.

The CDR unit 140 may include, or may be operatively associated with, a frequency tracker 150. Frequency tracker 150 may, for example, detect and/or calculate a frequency offset of the signal received by receiver 172, for example, a difference between the frequency of the signal received by receiver 172 and the expected frequency of that signal. The frequency offset may be measured, for example, in PPM.

The CDR unit 140 may, for example, generate a correcting signal to automatically correct the data sampling point. The correcting signal may contain pulses at time intervals T[ns]. The pulse interval T may be determined by the frequency offset of the incoming data 134, for example, as described in detail below. Frequency tracker 150 may be able to track, for example, small frequency offsets and/or large frequency offsets, thereby allowing accurate sampling position control.

Although FIG. 1 shows, for demonstrative purposes, CDR unit 140 and frequency tracker 150 as components of station 120 and receiver 172, embodiments of the invention are not limited in this regard. For example, in some embodiments, CDR unit 140 and frequency tracker 150 may be included in receiver 112 and/or station 110. In some embodiments, for example, communications and/or operations described herein with reference to transmitter 111 and receiver 172 may be similarly used in conjunction with transmitter 111 and receiver 112, respectively. In some embodiments, for example, system 100 may be implemented as a wired communication system, including, for example, one or more computing platforms, processing platforms, PCIe devices, PCIe transmitters/receivers, serializer/deserializer (SerDes) devices, SerDes transmitters/receivers, or the like. In some embodiments of the invention, for example, embodiments wherein system 100 is implemented as a wired communication system, the transmitter and receiver, e.g., transmitter 171 and receiver 172, may be internal components of the same computing platform.

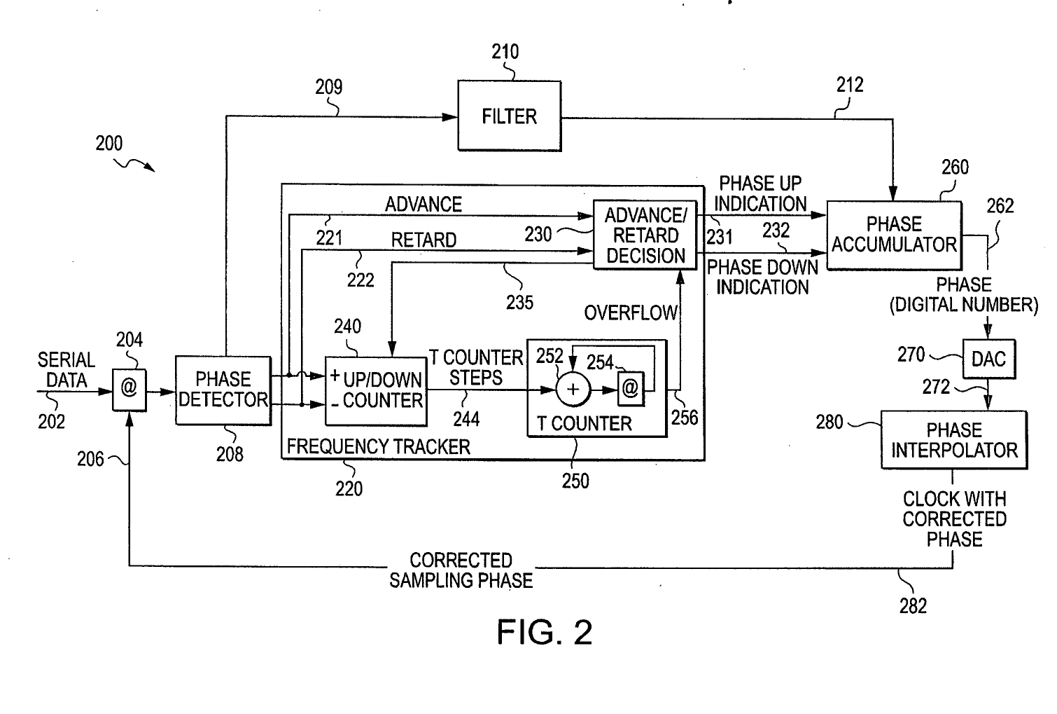

Reference is made to FIG. 2, which schematically illustrates a CDR unit 200 of a receiver in accordance with a demonstrative embodiment of the invention, for example, of receiver 172 or receiver 112 of FIG. 1. The CDR unit 200 may include, or may be operatively associated with, a frequency tracker 220. Although the invention is not limited in this respect, CDR unit 200 and frequency tracker 220 may be demonstrative examples of CDR unit 140 and frequency tracker 150 of FIG. 1, respectively.

CDR unit 200 may include, for example, a sampler 204, a phase detector 208, a filter 210, frequency tracker 220, a phase accumulator 260, a digital-to-analog converter (DAC) 260, and a phase interpolator 280. Frequency tracker 220 may include, for example, an advance/retard decision module 230, an up/down counter 240, and a T-counter 250.

According to some demonstrative embodiments of the invention, a received signal, e.g., a signal received by receiver 172 of FIG. 1, may carry serial data 202 to be processed by CDR unit 200. For example, serial data 202 may be high speed serial data at a speed of over 1 GHz, e.g., approximately 2.5 GHz in accordance with the PCIe communication standard. In addition, serial data 202 may carry embedded clocking information of the transmitting clock, e.g., clock 115 of FIG. 1. It will be appreciated that such embedded clocking information may allow reconstruction of transmitter clock 115 from the received data, for example, by analyzing the position of one or more edges of the received data 202. For example, sampler 204, e.g., a sampling flip-flop, as is known in the art, may sample serial data 202 at, e.g., two points, under the control of a system clock, e.g., clock 175 of FIG. 1. The phase of the sampling, for example, may be controlled by a corrected sampling signal 206 and may vary according to the output of phase accumulator 260, e.g., as explained in detail below.

According to some demonstrative embodiments of the invention, serial data 202 may enter a phase detector 208. The phase detector 208 may detect a change in phase, e.g., in frequency domain and/or time domain, between two consecutive sampling points. In some embodiments, phase detector 208 may send an indication to the frequency tracker 220 that the sampling point of sampler 204 is either too early or too late. For example, phase detector may send an advance signal 221 in order to indicate that the sampling point should be advanced, e.g., if the incoming bits are sampled too late, or a retard signal 222 to indicate that the sampling point should be delayed, e.g., if the incoming bits are sampled too early. In some embodiments, for example, phase detector 208 may send advance signal 221 or retard signal 222 based on, e.g., an 8-bit history obtained from four consecutive samplings of serial data 202, to prevent or reduce hyper-sensitivity of frequency tracker 220. In some embodiments, advance/retard signals 221 and 222 may be or may include binary indicators, or may include a value corresponding to the degree of phase change detected.

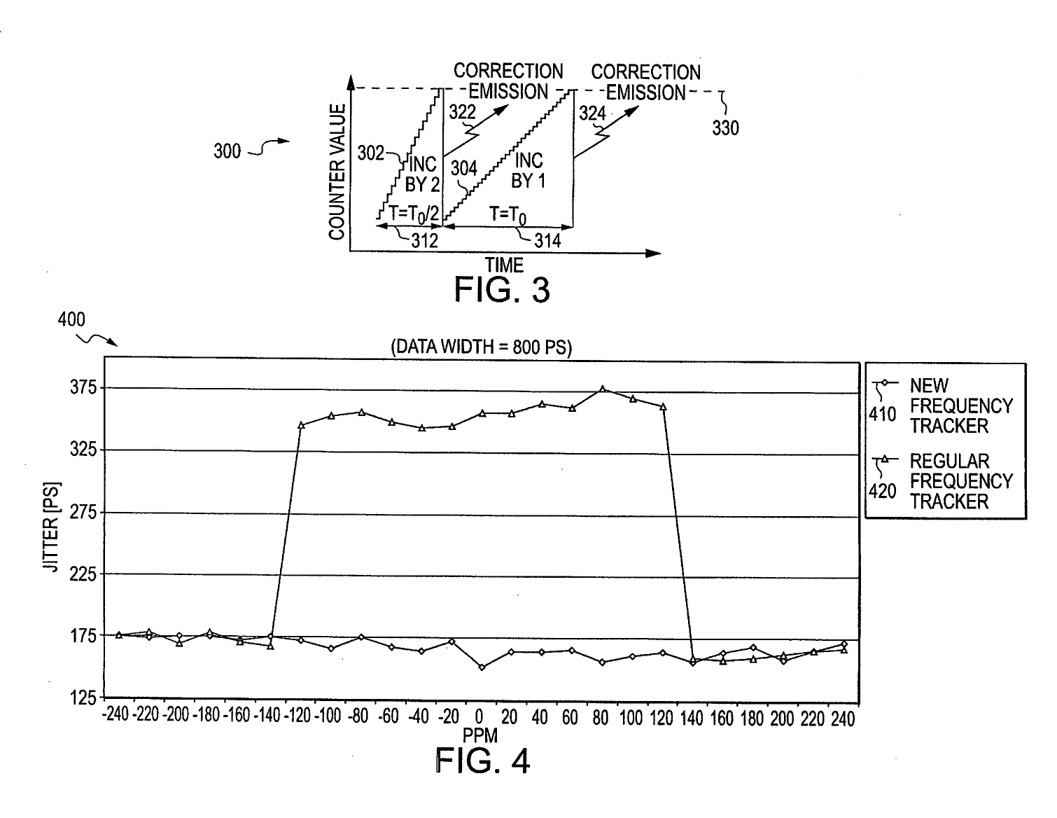

In some embodiments, advance/retard signals 221 and 222 may be used as input to advance/retard decision module 230 and to up/down counter 240. The operation of the up/down counter 240 is explained in more detail below, e.g., with reference to FIG. 3. Based on the signals 221 and 222, advance/retard decision module 230 may be able to determine the current trend of frequency offsets, e.g., whether the received data frequency is smaller than expected or larger than expected, and may generate either a “phase-up” indication 231 or a “phase-down” indication 232, accordingly. For example, advance/retard decision module 230 may include one or more counters to track and compare the prevalence of advance signal 221 versus retard signal 222, e.g., per a certain number of inputs. For example, advance/retard decision module 230 may be able to be in either an “advance” state, a “retard” state, or a “neutral” state, and an input signal may increment the one or more internal counters of decision module 230 towards the state corresponding to the signal. If the advance/retard decision module 230 is in a neutral state, e.g., if the number of input bits from advance signal 221 is equal to the number of input bits from retard signal 222, thereby balancing each other out, no phase correction indication may be sent.

In some embodiments, up/down counter 240 may receive inputs 221 and 222 (advance and retard indications, respectively), and, in response to these inputs, up/down counter 240 may increment or decrement. Up/down counter output signal 244 may reach a value representing the difference between a local (e.g., receiver-associated) clock frequency and another (e.g., transmitter-associated) clock frequency. In some embodiments, at pre-defined time intervals e.g., at time intervals substantially equal to a local clock cycle or a receiver-associated clock cycle, the value of output signal 244 may be sent by up/down counter 240 to the T-counter 250. For example, T-counter 250 may be a variable step counter that uses a variable step increment value, e.g., the value received in output signal 244 from up/down counter 240. In other embodiments, output signal 244 may be constant, but the variable step value may be transmitted periodically. For example, signal 244 may carry a value of 0 when not transmitting a step increment value. In some embodiments, a direct relation may exist between the size of the frequency offset and the affect on the T-counter 250; for example, a relatively large frequency offset may result in a more frequent correction.

In some embodiments, whether an input may cause an increment or a decrement of up/down counter 240 may depend on the current state stored in the decision module 230. For example, if the current state is advance, then an advance signal input 221 may be an increment of counter 240, since it is an indication that advance is currently needed. In contrast, if the state is retard, then an advance signal input may cause a decrement, since it is an indication that retard is not currently needed. For example, information regarding the current state in decision module 230 may be sent to up/down counter 240 via signal 235.

In some embodiments, at balance (e.g., when the transmitter clock and the receiver clock are in substantial alignment), the advance/retard increments/decrements may cancel each other out, and as a result the value 244 may be equal to zero, and the value of the T-counter 250 may not change. The operation of T-counter 250 is explained in more detail below, e.g., with reference to FIG. 3.

According to some demonstrative embodiments of the invention, a step increment value in output signal 244, responsive to the frequency offset, may be received from up/down counter 240. Adder 252 may add the received value 254 to the current step size, e.g., stored in a register 254. It is noted that the value in 244 may optionally be negative, thereby decreasing the size of the step stored in register 254. In some embodiments, the T-counter 250 may overflow, e.g., reach a positive value larger than a positive threshold, or reach a negative value smaller than a negative threshold. In some embodiments, the value in 254 may always be a positive value between 0 and the positive overflow threshold. As a result, an overflow signal 256 may be sent to decision module 230, e.g., to trigger a frequency offset correction signal.

Although embodiments of the invention are not limited in this respect, phase accumulator 260 may accumulate the phase up indications 231 and/or the phase down indications 232 from the decision module 230, and may generate a phase, e.g., represented using a digital value 262. The DAC 260 may convert the digital value 262 to a corresponding analog signal 272 transferred to the phase interpolator 280. The phase interpolator 280 may close a feedback loop, for example, by sending a clock signal having a controlled phase, thereby allowing the sampler 204 to utilize a corrected sampling phase. For example, phase interpolator 208 may be part of a sampling point position control mechanism that may, e.g., delay or advance a local clock (e.g., a clock associated with the frequency tracker 220 or CDR unit 200) by the phase estimated by the CDR unit 200. The phase-corrected clock signal 282 may be used, for example, in subsequent sampling operations of subsequent data. Accordingly, the CDR unit 200 may allow the local clock to fit the received data and to sample it in substantially the best position.

In some embodiments, phase detector 208 may additionally transfer an advance/retard indication 209 to filter 210. The filter 210 may produce an advance/retard indication 210 for a certain period of time, e.g., optionally a variable-length time period. For example, filter 210 may be implemented using an up/down counter that may count up for advance and may count down for retard. When the counter reaches a pre-defined positive threshold, an advance indication may be generated; and when the counter reaches a pre-defined negative threshold, a retard indication may be generated. The advance/retard indication 212 of the filter 210 may be provided to the phase accumulator 260. For example, in some embodiments, the phase accumulator 260 may modify its output according to indications received from both the filter 210 and the decision module 230.

Reference is made to FIG. 3, which schematically illustrates a graph 300 of counter values as a function of time in accordance with some demonstrative embodiments of the invention. Although the invention is not limited in this respect, graph 300 may correspond to the operation of T-counter 250, e.g., as described above with reference to FIG. 2.

As illustrated, graph 300 may represent the current counter value as a function of time. In some embodiments, the variable-slope counter, e.g., T-counter 250, may have a fixed overflow threshold value 330, e.g., denoted V. In some embodiments, the threshold value 330 may depend on the number of bits in register 254, for example, a 10-bit register 254 may result in a threshold value of V=1024 (2¹⁰). When threshold value 330 is reached, the counter may overflow and trigger a correction signal, e.g., correction emissions 322 and 324. After overflow, the counter may be reset to an initial value. In some embodiments, the time needed to reach overflow threshold value 330, i.e., the time between two successive correction signals, may depend on the slope of the counter steps.

Counter incrimination may be performed, for example, at a substantially fixed step per time unit rate; in contrast, the increment step may be variable. For example, a larger step increment value may result in a sharper slope and a faster overflow. In some embodiments, for example, counter value slope 302, corresponding to a step increment value of two, may result in an overflow time 312 which may be equal to T=T₀/2; whereas counter value slope 304, corresponding to a step increment value of one, may result in an overflow time of T=T₀. In some embodiments, for example, an inverse relation may exist between the increment size and the overflow interval.

In some embodiments, the step increment value may be responsive to the frequency offset, e.g., due to the operation of up/down counter 240 as explained above. For large frequency offsets, a relatively short overflow interval may be utilized, e.g., to allow rapid correction. For small frequency offsets, a relatively long interval between corrections may be utilized. In some embodiments, for example, the increment value may be responsive to the frequency offset size, thereby allowing suitable modifications of the correction intervals.

For example, a value Tₘₐₓ may be defined as the maximum possible number for the step-increment value in up/down counter output signal 244. It will be appreciated that Tₘₐₓ may depend on the number of bits used to implement up/down counter 240, e.g., 9 bits may result in a value of Tₘₐₓ=512 (2⁹). In some embodiments, for example, the number of clock cycles between two successive correction emissions may be equal to V/Tₘₐₓ. Thus, in one embodiment, for example using the values V=1024 and Tₘₐₓ=512, the number of clock cycles between two corrections may be two, such that a correction may be performed substantially every second local clock cycle. It will be appreciated that, for large frequency offsets, the step increment value in output signal 244 may approach Tₘₐₓ, resulting in rapid corrections, as described above. Although embodiments of the invention are not limited in this respect, the highest possible frequency of corrections may not limited, e.g., CDR 200 may be able to correct larger frequency offsets than required by the PCIe and/or SerDes specifications.

In some embodiments, the variable-step counter, e.g., T-counter 250, may utilize “fraction bits”, for example, to support small frequency offsets and/or to allow the counter value slope to be smaller than one. Although embodiments of the invention are not limited in this respect, for small frequency offsets, e.g., ±100 ppm, the step increment value in up/down counter output signal 244 may be substantially constant, for example, with variation of the least significant bit (LSB). In some embodiments, the LSB of the step increment value may be added to the LSB of the counter value of T-counter 250, which may result in a fractional increment. For example, in one embodiment, five fraction bits may be utilized in T-counter 250, which may enable an interval of up to 32·T₀ between two successive corrections, where T₀ is the interval corresponding to a counter value slope with an increment step of one, e.g., interval 314. In some embodiments, for example, the number of bits utilized in T-counter 250 to trigger overflow signal 256 may be determined by the smallest frequency offset required to be tracked for a constant value of up/down counter, e.g., when/if the step-increment value in output signal 244 is constant.

In some embodiments, after correction signal 322 is sent, the frequency offset may be decreased. Thus, for example, counter value slope 304 may be shallower than counter value slope 302. For example, when a balance is reached, subsequent slopes may stabilize and correction signals may be sent periodically.

Reference is made to FIG. 4, which schematically illustrates a graph 400 of jitter versus frequency offset when using a frequency tracker in accordance with a demonstrative embodiment of the invention. Although embodiments of the invention are not limited in this respect, graph 400 may represent performance results of frequency tracker 220, e.g., described above with reference to FIGS. 2 and 3. For example, the values illustrated in graph 400 may correspond to simulation results of a CDR unit having a frequency tracker in accordance with embodiments of the invention, compared to a CDR unit having a conventional frequency tracker.

As indicated at graph line 410, use of a frequency tracker in accordance with embodiments of the invention may result in signal jitter of, e.g., approximately 175 picoseconds (ps) out of a data width of approximately 800 ps, for both small and large frequency offsets. In contrast, as indicated at graph line 420, use of a frequency tracker that treats small frequency offsets as jitter, e.g., to be handled by a filter of the CDR unit, may result in signal jitter of, e.g., approximately 350 ps for frequency offsets smaller than 125 ppm. In some embodiments, utilizing a frequency tracker (e.g., frequency tracker 220) for small frequency offsets may reduce internal tracking error and/or overall signal jitter. For example, as indicated by graph 400, the signal jitter for frequency offsets of less than 125 ppm may be twice as large when the frequency tracker is not used.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by system 100 of FIG. 1, by station 110 of FIG. 1, by station 120 of FIG. 1, or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 152, memory unit 162, storage unit 153, or storage unit 163), memory device, memory article, memory medium, storage device, storage article, storage medium and/or storage unit, for example, memory, removable or non-removable media, erasable or non-erasable media, writeable or re-writeable media, digital or analog media, hard disk, floppy disk, compact disk read only memory (CD-ROM), compact disk recordable (CD-R), compact disk re-writeable (CD-RW), optical disk, magnetic media, various types of digital versatile disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art It is, therefore, to be understood that the appended claims are intended to cover all such modifications and changes as fall within the true spirit of the invention.

### APPENDIX A

These attorneys and agents are associated with Customer Number 49444.

Alan K. Aldous, Reg. No. 31,905; Rob D. Anderson, Reg. No. 33,826; Shireen L Bacon, Reg. No. 40,494; Michael Barre, Reg. No. 44,023; Jay P. Beale, Reg. No. 50,901; R. Edward Brake, Reg. No. 37,784; Ben Burge, Reg. No. 42,372; George Chen, Reg. No. 50,807; Glen B. Choi, Reg. No. 43,546; Kenneth Cool, Reg. No. 40,570; Ted A. Crawford, Reg. No. 50,610; Robert Diehl, Reg. No. 40,992; Jeffrey S. Draeger, Reg. No. 41,000; Cynthia Thomas Faatz, Reg No. 39,973; Christopher Gagne, Reg. No. 36,142; Sharmini N. Green, Reg. No. 41,410; Robert Greenberg, Reg. No. 44,133; Bradley Greenwald, Reg. No. 34,341; Julia Hodge, Reg. No. 46,775; Libby Hope, Reg. No. 46,774; Jeffrey B. Huter, Reg. No. 41,086; B. Delano Jordan, Reg. No. 43,698; Seth Z. Kalson, Reg. No. 40,670; Issac Lin, Reg. No. 50,672; Anthony Martinez, Reg. No. 44,223; Molly McCall, Reg. No. 46,126; Larry Mennemeier, Reg. No. 51,003; Paul Nagy, Reg. No. 37,896; Michael J. Nesheiwat, Reg. No. 47,819; Dennis A. Nicholls, Reg. No. 42,036; Lanny Parker, Reg No. 44,281; Alan Pedersen-Giles, Reg. No. 39,996; Michael D. Plimier, Reg. No. 43,004; Michael Proksch, Reg. No. 43,021; Kevin A. Reif, Reg. No. 36,381; Crystal D. Sayles, Reg. No. 44,318; Russell Scott, Reg. No. 43,103; Kenneth M. Seddon, Reg. No. 43,105; Mark Seeley, Reg. No. 32,299; Ami P. Shah, Reg. No. 42,143; David Simon, Reg. No; 32,756; Steven P. Skabrat, Reg. No. 36,279; Paul E. Steiner, Reg. No. 41,326; Joni D. Stutman-Horn, Reg. No. 42,173; David Tran, Reg. No. 50,804; John F. Travis, Reg. No. 43,203; Kerry Tweet, Reg. No. 45,959; Calvin E. Wells, Reg. No. 43,256; Stuart Whittington, Reg. No. 45,215; Michael Willardson, Reg. No. 50,856; Robert Winkle, Reg. No. 37,474; Rita Wisor, Reg. No. 41,382; Sharon Wong, Reg. No. 37,760; and Steven D. Yates, Reg. No. 42,242; my patent attorneys, and my patent agents, of INTEL CORPORATION, with offices located at 2200 Mission College Blvd., Santa Clara, CALIF. 95052, telephone (408)765-8080; with full power of substitution and revocation, to prosecute this application and to tract all business in the Patent and Trademark Office connected herewith. These attorneys and agents are associated with Customer Number 49444.

What is claimed is:

1. An apparatus comprising:
a frequency tracker to correct a frequency offset of a received signal in response to an
overflow signal of a variable-step counter that uses a variable step increment value.

2. The apparatus of claim 1, comprising:
an up/down counter to generate said variable step increment value in response to a count
of one or more advance indications, a count of one or more retard indications, and a
current trend of the advance and retard indications.

3. The apparatus of claim 2, comprising:
a phase detector to detect a frequency offset in said received signal and, in response to the
frequency offset, to generate said advance indication or said retard indication.

4. The apparatus of claim 2, wherein said frequency tracker comprises an advance/retard decision module able to generate a phase change indication triggered by said overflow signal.

5. The apparatus of claim 4, wherein said advance/retard decision module is able to receive said advance and retard indications and to provide to said up/down counter an input responsive to said current trend of the one or more advance and retard indications.

6. The apparatus of claim 4, wherein said phase change indication corresponds to an internal state of said advance/retard decision module, said internal state is determined based on said one or more advance and retard indications.

7. The apparatus of claim 3, wherein said step increment value is increased in response to an increase in said frequency offset, and wherein said step increment value is decreased in response to a decrease in said frequency offset.

8. The apparatus of claim 1, wherein said received signal comprises a high speed serial data signal.

9. A method comprising:
correcting a frequency offset of a received signal in response to an overflow signal of a
variable-step counter that uses a variable step increment value.

10. The method of claim 9, comprising:
generating said variable step increment value in response to a count of one or more
advance indications, a count of one or more retard indications, and a current trend of the
one or more advance and retard indications.

11. The method of claim 10, comprising:
detecting a frequency offset in said received signal and, in response to the frequency
offset, generating said advance indication or said retard indication.

12. The method of claim 10, comprising:
generating a phase change indication in response to said overflow signal.

13. The method of claim 12, comprising receiving said one or more advance and retard indications, wherein generating the phase change indication comprises generating the phase change indication based on one or more advance and retard indications.

14. The method of claim 11, wherein generating said variable step increment value comprises increasing said variable step increment value when said frequency offset increases, and decreasing said variable step increment value when said frequency offset decreases.

15. A system comprising:
a communication device including a receiver to receive a signal from an access medium,
a frequency tracker to correct a frequency offset of said signal in response to an overflow
signal of a variable-step counter that uses a variable step increment value, and a memory
to store data from said signal.

16. The system of claim 15, comprising:
an up/down counter to generate said variable step increment value in response to a count
of one or more advance indications, a count of one or more retard indications, and a
current trend of the advance and retard indications.

17. The system of claim 16, comprising:
a phase detector to detect a frequency offset in said received signal and, in response to the frequency offset, to generate said advance indication or said retard indication.

18. The system of claim 16, wherein said frequency tracker comprises an advance/retard decision module able to generate a phase change indication triggered by said overflow signal.

19. The system of claim 18, wherein said advance/retard decision module is able to receive said advance and retard indications and to provide to said up/down counter an input responsive to said current trend of the one or more advance and retard indications.

20. The system of claim 18, wherein said phase change indication corresponds to an internal state of said advance/retard decision module, said internal state is determined based on said one or more advance and retard indications.

21. The system of claim 17, wherein said step increment value is increased in response to an increase in said frequency offset, and wherein said step increment value is decreased in response to a decrease in said frequency offset.

22. The system of claim 15 wherein said received signal comprises a high speed serial data signal and wherein said access medium comprises a serial interface.

23. The system of claim 15, wherein said communication device comprises a wireless communication device, and wherein said receiver comprises a wireless receiver having an antenna to receive said signal. 24. The system of claim 23, comprising an additional wireless communication device to transmit said received signal, and wherein said access medium comprises a shared access medium of a wireless communication network.
